(19) United States
(12) Patent Application Publication
(10) Pub. No.: US 2011/0169712 A1
(43) Pub. Date: Jul. 14, 2011

(54) PORTABLE RADIO EQUIPMENT

(75) Inventors: Shingo Sumi, Miyagi (JP); Kenya Nagano, Miyagi (JP); Haruhiko Kakitsu, Miyagi (JP); Yukari Yamazaki, Miyagi (JP); Hiroyuki Uejima, Miyagi (JP); Hideki Hayama, Kanagawa (JP)

(73) Assignee: PANASONIC CORPORATION, Osaka (JP)

(21) Appl. No.: 12/989,323

(22) PCT Filed: Dec. 22, 2008
(86) PCT No.: PCT/JP08/03903

§ 371 Date: Oct. 22, 2010

(30) Foreign Application Priority Data
Apr. 24, 2008 (JP) 2008-113786

(51) Int. Cl. H01Q 21/30

(52) U.S. Cl. 343/893

(57) ABSTRACT

When three or more antennas and a plurality of wireless circuits using wireless frequency bands near to each other are installed on a cabinet whose size is limited, degradation of characteristic caused by electromagnetic coupling between antennas is suppressed. When a first antenna 21 and a second antenna 22 are connected to a first wireless circuit 31, a third antenna 23 is connected to a second wireless circuit 32, and an operation frequency band of the second wireless circuit 32 is near in a higher band than an operation frequency band of the first wireless circuit 31, a feeding point 23a of the third antenna is placed at a position nearer to a feeding point 21a of the first antenna than the feeding point 22a of the second antenna. In the operation frequency band of the first wireless circuit 31, the gain of the first antenna 21 is set higher than the gain of the second antenna 22 in a low frequency band and the gain of the first antenna 21 is set higher than the gain of the second antenna 22 in a high frequency band.

### TECHNICAL FIELD

This invention relates to a mobile wireless terminal including a plurality of antennas and a plurality of wireless circuits.

### BACKGROUND ART

For example, a mobile wireless terminal such as a mobile telephone terminal often includes not only a cellular wireless communication function required for securing a wireless link used for conversation, packet communications, etc., but also a wireless communication function for receiving a digital broadcast (DTV) like a TV program broadcasted as so-called one seg (trademark) broadcast.

In such a mobile wireless terminal having the digital broadcast reception function, an independent antenna for receiving the digital broadcast also becomes necessary in addition to an antenna used for the cellular wireless communication function. Since the frequency band of a digital broadcast to be received is very wide, it is often difficult for only a single antenna to receive all digital broadcasts with sufficient quality.

By the way, to install a plurality of antennas on a small-sized cabinet like a mobile wireless terminal, if the frequency bands used by the antennas are close to each other, the plurality of antennas interfere with each other because of electromagnetic coupling and thus performance of each antenna degrades.

To deal with such a problem, in an art disclosed, for example, in Patent Document 1, a foldable cabinet is provided, one of antennas is placed in a hinge part of the cabinet, and another antenna is placed at a position opposite to the hinge part of the cabinet for enlarging the distance between the antennas.
Patent Document 1: JP-A-2004-153589

### DISCLOSURE OF THE INVENTION

### Problems to be Solved by the Invention

However, if the position relationship of placement of antennas is devised as disclosed in Patent Document 1, when the size of the cabinet is very small, it is difficult to provide a sufficient distance between antennas. Particularly, if three or more antennas are mounted on one cabinet, a situation in which the distance between two of the three antennas is close is not circumvented.

For example, to install a cellular wireless communication function and a digital broadcast reception function in a mobile wireless terminal, if the frequency band of the former is 800 MHz and the frequency band of the latter is 473 MHz to 770 MHz, the frequency bands of both are adjacent to each other. Thus, an antenna used for the cellular wireless communication function and an antenna used for the digital broadcast reception function interfere with each other because of electromagnetic coupling unless the distance between the antennas is made large.

Since the frequency band of digital broadcast (473 MHz to 770 MHz) is very wide, it is difficult for only a single antenna to realize an antenna having a sufficient gain throughout the frequency band. Then, to improve the reception characteristic, it is considered that a plurality of antennas are provided for the digital broadcast reception function and diversity reception is performed. However, to do this, the three or more antennas are mounted on one cabinet whose size is limited and thus a situation in which the mutual distance of the three antennas further lessens is not circumvented and degradation of the antenna characteristic introduces a problem.

In view of the circumstances described above, it is an object of the invention to provide a mobile wireless terminal capable of suppressing degradation of characteristic caused by electromagnetic coupling between antennas when three or more antennas and a plurality of wireless circuits using wireless frequency bands near to each other are mounted on a cabinet whose size is limited.

The present invention provides a mobile wireless terminal comprising, a board; a first wireless circuit which is mounted on the board and is adapted to perform diversity reception operation; a second wireless circuit mounted on the board; a first antenna connected to the first wireless circuit; a second antenna connected to the first wireless circuit; and a third antenna connected to the second wireless circuit, wherein a feeding point of the third antenna is placed at a position nearer to a feeding point of the first antenna than a feeding point of the second antenna; wherein the second wireless circuit operates in a second operation frequency band higher than a first operation frequency band in which the first wireless circuit operates, the second operation frequency band being near to the first operation frequency band; and wherein a resonance frequency of the second antenna is set in a frequency band higher than a resonance frequency of the first antenna in the first operation frequency band.

According to the configuration described above, the feeding point of the third antenna is placed at the position nearer to the feeding point of the first antenna than the feeding point of the second antenna. Thus, when the cabinet is small, etc., the distance between the first antenna and the third antenna is near and there is a possibility that both may interfere with each other because of electromagnetic coupling. However, the resonance frequency of the first antenna is set lower than the resonance frequency of the second antenna, whereby the mutual effect of the first antenna and the third antenna can be decreased. In this case, in the frequency characteristic of the antenna, the resonance frequency of the first antenna and the resonance frequency of the third antenna are separated from each other, and the effect of the first antenna lessens in the operation frequency band of the second wireless circuit to which the third antenna is connected. That is, even if the cabinet is small and the first antenna and the third antenna cannot be placed at a sufficient distance from each other relative to the wavelength of the used frequency band, degradation of the characteristic caused by interference of both antennas can be suppressed. The feeding point of the second antenna is at a farther position than the feeding point of the first antenna relative to the feeding point of the third antenna and the second antenna and the third antenna can be placed at a distance from each other, so that even if the operation frequency bands of both antennas are near, interference can be suppressed. Since the first wireless circuit can perform diversity reception operation using the first antenna and the second antenna different in resonance frequency, even if the operation frequency band of the first wireless circuit is very wide, it is made possible to ensure a sufficient antenna gain over all band of the first operation frequency band. Each antenna is an antenna element or contains an antenna element and circuit elements of matching circuits, an amplifier connected to the antenna element.

Also, in the mobile wireless terminal, an antenna gain of the first antenna is higher than an antenna gain of the second antenna at least in a low frequency band in the proximity of a lower limit frequency in the first operation frequency band, and the antenna gain of the second antenna is higher than the antenna gain of the first antenna at least in a high frequency band in the proximity of an upper limit frequency in the first operation frequency band.

According to the configuration described above, as the frequency characteristics of the antennas, the antenna gain of the first antenna is smaller than the antenna gain of the second antenna in a high frequency band in the proximity of the upper limit frequency of the first operation frequency band. Thus, the effect of the first antenna on the third antenna can be lessened in the second operation frequency band near to the high band side of the first operation frequency band, electromagnetic coupling of both antennas becomes hard to occur, and interference between the first antenna and the third antenna can be decreased. Thus, even in a situation in which the first antenna and the third antenna cannot be placed at a large distance from each other relative to the wavelength of the used frequency band, degradation of the characteristic caused by interference of both antennas can be suppressed.

Also, in the mobile wireless terminal, the first antenna is connected to the first wireless circuit through a first input terminal, the second antenna is connected to the first wireless circuit through a second input terminal, and an input signal to noise ratio in the first input terminal is higher than an input signal to noise ratio in the second input terminal at least in a low frequency band in the proximity of a lower limit frequency in the first operation frequency band, and the input signal to noise ratio in the second input terminal is higher than the input signal to noise ratio in the first input terminal at least in a high frequency band in the proximity of an upper limit frequency in the first operation frequency band.

According to the configuration described above, as the frequency characteristics of the antennas, the input signal to noise ratio in the first input terminal is smaller than the input signal to noise ratio in the second input terminal in a high frequency band in the proximity of the upper limit frequency of the first operation frequency band. Thus, the effect of the first antenna on the third antenna can be lessened in the second operation frequency band near to the high band side of the first operation frequency band, electromagnetic coupling of both antennas becomes hard to occur, and interference between the first antenna and the third antenna can be decreased. Thus, even in a situation in which the first antenna and the third antenna cannot be placed at a large distance from each other relative to the wavelength of the used frequency band, degradation of the characteristic caused by interference of both antennas can be suppressed.

The present invention also provides a mobile wireless terminal comprising: a board; a first wireless circuit which is mounted on the board and is adapted to perform diversity reception operation; a second wireless circuit mounted on the board; a first antenna connected to the first wireless circuit; a second antenna connected to the first wireless circuit; and a third antenna connected to the second wireless circuit, wherein a feeding point of the third antenna is placed at a position nearer to a feeding point of the first antenna than a feeding point of the second antenna; wherein the second wireless circuit operates in a second operation frequency band lower than a first operation frequency band in which the first wireless circuit operates, and the second operation frequency band being near to the first operation frequency band; and wherein a resonance frequency of the second antenna is set in a frequency band lower than a resonance frequency of the first antenna in the first operation frequency band.

According to the configuration described above, the feeding point of the third antenna is placed at the position nearer to the feeding point of the first antenna than the feeding point of the second antenna. Thus, when the cabinet is small, etc., the distance between the first antenna and the third antenna is near and there is a possibility that both may interfere with each other because of electromagnetic coupling; the resonance frequency of the first antenna is set higher than the resonance frequency of the second antenna, whereby the mutual effect of the first antenna and the third antenna can be decreased. In this case, in the frequency characteristic of the antenna, the resonance frequency of the first antenna and the resonance frequency of the third antenna are at a distance from each other and the effect of the first antenna lessens in the operation frequency band of the second wireless circuit to which the third antenna is connected. That is, even if the cabinet is small and the first antenna and the third antenna cannot be placed at a sufficient distance from each other relative to the wavelength of the used frequency band, degradation of the characteristic caused by interference of both antennas can be suppressed. The feeding point of the second antenna is at a farther position than the feeding point of the first antenna relative to the feeding point of the third antenna and the second antenna and the third antenna can be placed at a distance from each other, so that even if the operation frequency bands of both antennas are near, interference can be suppressed. Since the first wireless circuit can perform diversity reception operation using the first antenna and the second antenna different in resonance frequency, even if the operation frequency band of the first wireless circuit is very wide, it is made possible to ensure a sufficient antenna gain over all band of the first operation frequency band.

Also, in the mobile wireless terminal, an antenna gain of the first antenna is higher than an antenna gain of the second antenna at least in a high frequency band in the proximity of an upper limit frequency in the first operation frequency band, and the antenna gain of the second antenna is higher than the antenna gain of the first antenna at least in a low frequency band in the proximity of a lower limit frequency in the first operation frequency band.

According to the configuration described above, as the frequency characteristics of the antennas, the antenna gain of the first antenna is smaller than the antenna gain of the second antenna in a low frequency band in the proximity of the lower limit frequency of the first operation frequency band. Thus, the effect of the first antenna on the third antenna can be lessened in the second operation frequency band near to the low band side of the first operation frequency band, electromagnetic coupling of both antennas becomes hard to occur, and interference between the first antenna and the third antenna can be decreased. Thus, even in a situation in which the first antenna and the third antenna cannot be placed at a large distance from each other relative to the wavelength of the used frequency band, degradation of the characteristic caused by interference of both antennas can be suppressed.

Also, in the mobile wireless terminal, the first antenna is connected to the first wireless circuit through a first input terminal, the second antenna is connected to the first wireless circuit through a second input terminal, an input signal to noise ratio in the first input terminal is higher than the input signal to noise ratio in the second input terminal at least in a high frequency band in the proximity of an upper limit frequency in the first operation frequency band, and the input signal to noise ratio in the second input terminal is higher than the input signal to noise ratio in the first input terminal at least in a low frequency band in the proximity of a lower limit frequency in the first operation frequency band.

According to the configuration described above, as the frequency characteristics of the antennas, the input signal to noise ratio in the first input terminal is smaller than the input signal to noise ratio in the second input terminal in a low frequency band in the proximity of the lower limit frequency of the first operation frequency band. Thus, the effect of the first antenna on the third antenna can be lessened in the second operation frequency band near to the low band side of the first operation frequency band, electromagnetic coupling of both antennas becomes hard to occur, and interference between the first antenna and the third antenna can be decreased. Thus, even in a situation in which the first antenna and the third antenna cannot be placed at a large distance from each other relative to the wavelength of the used frequency band, degradation of the characteristic caused by interference of both antennas can be suppressed.

### Advantages of the Invention

According to the invention, there can be provided the mobile wireless terminal capable of suppressing degradation of characteristic caused by electromagnetic coupling between antennas when three or more antennas and a plurality of wireless circuits using wireless frequency bands near to each other are mounted on the cabinet whose size is limited.

### BRIEF DESCRIPTION OF THE DRAWINGS

FIG. 1 is a front view to represent the configuration of a main part of a mobile wireless terminal according to a first embodiment of the invention.

FIG. 2 is a characteristic drawing to represent specific examples of the frequency characteristic concerning the gain of each antenna and the operation frequency band of each wireless circuit mounted in the mobile wireless terminal according to the first embodiment.

FIG. 3 is a characteristic drawing to represent a specific example of the frequency characteristic of the signal to noise ratio (S/N) in the input terminal of each connected wireless circuit as for each antenna mounted in the mobile wireless terminal according to the first embodiment.

FIG. 4 is a configuration drawing to show a first configuration example of the antenna circuit of the mobile wireless terminal of the first embodiment.

FIG. 5 is a characteristic drawing to show the frequency characteristic of the first configuration example of the antenna circuit.

FIG. 6 is a configuration drawing to show a second configuration example of the antenna circuit of the mobile wireless terminal of the first embodiment.

FIG. 7 is a characteristic drawing to show the frequency characteristic of the second configuration example of the antenna circuit.

FIG. 8 is a configuration drawing to show a third configuration example of the antenna circuit of the mobile wireless terminal of the first embodiment.

FIG. 9 is a characteristic drawing to show the frequency characteristic of the third configuration example of the antenna circuit.

FIG. 10 is a configuration drawing to show a fourth configuration example of the antenna circuit of the mobile wireless terminal of the first embodiment.

FIG. 11 is a front view to represent the configuration of a main part of a mobile wireless terminal according to a second embodiment of the invention.

FIG. 12 is a characteristic drawing to represent specific examples of the frequency characteristic concerning the gain of each antenna and the operation frequency band of each wireless circuit mounted in the mobile wireless terminal according to the second embodiment.

FIG. 13 is a characteristic drawing to represent a specific example of the frequency characteristic of the signal to noise ratio (S/N) in the input terminal of each connected wireless circuit as for each antenna mounted in the mobile wireless terminal according to the second embodiment.

### DESCRIPTION OF REFERENCE NUMERALS

11 Lower cabinet
12 Upper cabinet
21 First antenna
22 Second antenna
23 Third antenna
21a, 22a, 23a Feeding point
30 Board
31 First wiring circuit
32 Second wiring circuit
31a, 31b, 32a Input terminal
41, 42 Matching circuit
43 Shut-off circuit
44 Amplifier
51 Shut-off circuit
52, 53, 56, 57 Matching circuit
54, 55 Amplifier
61 First antenna
62 Second antenna
63 Third antenna
61a, 62a, 63a Feeding point
71 First wireless circuit
72 Second wireless circuit
71a, 71b, 72a Input terminal

### BEST MODE FOR CARRYING OUT THE INVENTION

In embodiments, a configuration example wherein a mobile wireless terminal of the invention is applied to a mobile telephone terminal, etc., including a cellular wireless communication function and a digital broadcast reception function, used in a mobile communication system of a mobile telephone, etc., is shown as an example of a mobile wireless terminal.

### First Embodiment

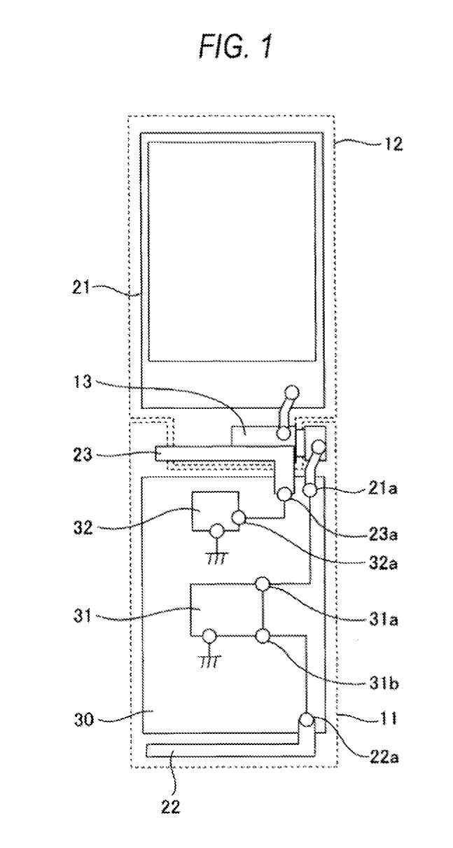

FIG. 1 is a front view to represent the configuration of a main part of a mobile wireless terminal according to a first embodiment of the invention. The mobile wireless terminal of the embodiment can be applied to a mobile telephone terminal, etc., and installs a cellular wireless communication function to secure a wireless link required for conducting voice conversation, conversation of a picture telephone, etc., and packet communications of electronic mail, etc. In the embodiment, a digital broadcast reception function for receiving a digital broadcast (DTV) like a TV program broadcasted as so-called One seg (trademark) broadcast is installed as a wireless function.

In the mobile wireless terminal of the embodiment, a cabinet can be folded. That is, the cabinet includes a lower cabinet 11, an upper cabinet 12, and a hinge 13 for joining the lower cabinet 11 and the upper cabinet 12. The lower cabinet 11 and the upper cabinet 12 can rotate relatively with a shaft of the hinge 13 as the center. Therefore, the cabinet can be placed in an open state as shown in FIG. 1 and the cabinet can be closed so that the lower cabinet 11 and the upper cabinet 12 overlap. In the example shown in FIG. 1, the cabinet of a structure wherein the upper end of the lower cabinet 11 and the lower end of the upper cabinet 12 are connected by the hinge 13 and the cabinet can be folded in a longitudinal direction in the figure is shown. However, if the hinge is placed rotatably with a side of the cabinet as a shaft, the structure can also be changed so as to open and close in a lateral direction in the figure.

In the mobile wireless terminal, a board 30 in which various electronic circuits are built is mounted on the lower cabinet 11 side. A first wireless circuit 31 and a second wireless circuit 32 are mounted on the board 30.

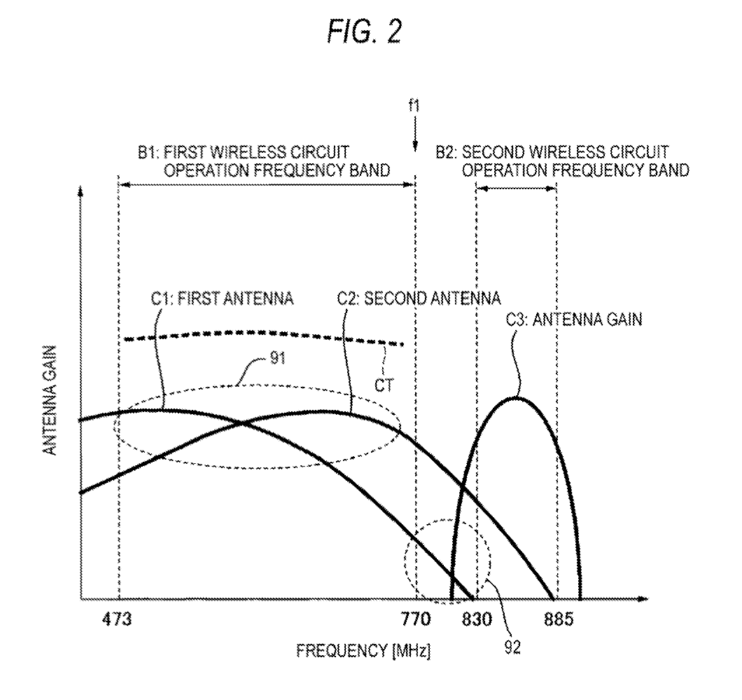

FIG. 2 is a characteristic drawing to represent specific examples of the frequency characteristic concerning the gain of each antenna and the operation frequency band of each wireless circuit installed in the mobile wireless terminal according to the first embodiment.

The first wireless circuit 31 is a circuit for implementing the digital broadcast reception function for receiving a digital broadcast and receives a wireless signal within the range of an operation frequency band B1 (473 MHz to 770 MHz). The second wireless circuit 32 is a circuit for implementing the cellular wireless communication function and has a function of conducting wireless communications using a signal within the range of an operation frequency band B2 (830 MHz to 885 MHz). The specific configuration and operation of the first wireless circuit 31 and the second wireless circuit 32 are similar to an art used with a general mobile telephone terminal, etc.

The cabinet of the mobile wireless terminal of the embodiment is provided with three independent antennas. That is, a first antenna 21 is placed on the upper cabinet 12 side, a second antenna 22 is placed on the lower end side of the lower cabinet 11 in the figure, namely, in the proximity of an end part opposite to the hinge, and a third antenna 23 is placed on the upper end side of the lower cabinet 11, namely, in the proximity of the end part on the hinge side (in the hinge or in the proximity of the hinge).

The first antenna 21 and the second antenna 22 are antennas for receiving a radio wave for a digital broadcast and are electrically connected to a first input terminal 31a and a second input terminal 31b of the first wireless circuit 31 respectively. The first wireless circuit 31 uses the first antenna 21 and the second antenna 22 to perform diversity reception operation. That is, reception signals of the antennas 21 and 22 different in frequency characteristic are combined, it is made possible to obtain a high antenna gain over a very wide frequency band.

The first antenna 21 functions as a dipole antenna using the cabinet. That is, a conductive metal frame which is formed so as to cover a wide range of the upper cabinet 12 is the main body of the first antenna 21. The metal frame is connected to the first input terminal 31a of the first wireless circuit 31 on the board 30 via the metal hinge 13 and a feeding point 21a. A ground pattern formed of metal foil exists on the board 30, and the metal frame of the first antenna, the hinge 13, and the ground pattern form the dipole antenna. On the other hand, the second antenna 22 is formed of an elongated metal member, etc., and functions as a monopole antenna.

In the example shown in FIG. 2, a characteristic curve C1 represents the frequency characteristic of the antenna gain concerning the first antenna 21, a characteristic curve C2 represents the frequency characteristic of the antenna gain concerning the second antenna 22, and a characteristic curve CT represents the frequency characteristic of total antenna gain obtained as a result of the diversity reception operation of the first antenna 21 and the second antenna 22.

That is, in the example shown in FIG. 2, a gain peak (corresponding to resonance frequency) exists on the low band side of the operation frequency band B1 about the characteristic of the first antenna 21 (C1), and a gain peak exists on the high band side of the operation frequency band B1 about the characteristic of the second antenna 22 (C2). That is, the first antenna 21 covers the low band of the operation frequency band B1 and the second antenna 22 covers the high band of the operation frequency band B1. The diversity reception operation is performed using the first antenna 21 and the second antenna 22, whereby the characteristic of the portion surrounded by a dashed line 91 in the figure is combined and as a result, a high antenna gain is obtained over all band of the operation frequency band B1 as indicated by the characteristic curve CT.

The third antenna 23 is an antenna for transmitting and receiving a radio wave for cellular wireless communications and is electrically connected to an input terminal 32a of the second wireless circuit 32. The third antenna 23 is formed of an elongated metal member, etc., and functions as a monopole antenna. In the example shown in FIG. 2, a characteristic curve C3 represents the frequency characteristic concerning the antenna gain of the third antenna 23. That is, a radio wave within the range of the operation frequency band B2 of the second wireless circuit 32 can be transmitted and received by using the third antenna 23.

The placement configuration and the frequency characteristics of the first antenna 21, the second antenna 22, and the third antenna 23 will be discussed in detail.

As shown in FIG. 1, the feeding point 21a of the first antenna 21 and a feeding point 23a of the third antenna 23 exist on the upper end side of the lower cabinet 11 in the figure and a feeding point 22a of the second antenna 22 exist on the lower end side of the lower cabinet 11 in the figure. Therefore, the distance between the first antenna 21 and the third antenna 23 and the second antenna 22 is comparatively large (for example, about 90 mm); whereas, the feeding point 21a of the first antenna 21 and the feeding point 23a of the third antenna 23 are near to each other.

Thus, interference is hard to occur between the first antenna 21 and the second antenna 22 and between the third antenna 23 and the second antenna 22; whereas, interference is easy to occur because of electromagnetic coupling between the first antenna 21 and the third antenna 23 near to each other.

In the embodiment, to suppress interference between the antenna because of electromagnetic coupling, the relative position relationship among the first antenna 21, the second antenna 22, and the third antenna 23 and the frequency characteristics of the first antenna 21 and the second antenna 22 are specially devised.

For example, the resonance frequency concerning the first antenna 21 (peak position of C1) and the resonance frequency concerning the second antenna 22 (peak position of C2) are deviated from each other like the frequency characteristic of antenna gain shown in FIG. 2 and about the first antenna 21 near to the feeding point 23a of the third antenna 23, the antenna gain at least at upper limit frequency f1 (770 MHz) as shown in characteristic curve C1 is smaller than characteristic curve C2 of antenna gain characteristic of the second antenna 22.

Accordingly, the resonance frequency concerning the first antenna 21 (peak position of C1) is at a large distance from the upper limit frequency f1 and the operation frequency band B2 and the antenna gain of the first antenna 21 becomes sufficiently low in the operation frequency band B2 like the portion surround by a dashed line 92 in the figure. Therefore, electromagnetic coupling of the third antenna 23 operating in the operation frequency band B2 with the first antenna 21 is hard to occur although the distance is near, and interference of the third antenna 23 and the first antenna 21 is suppressed.

In the second antenna 22, the resonance frequency (peak position of C2) is near to the upper limit frequency f1 and the operation frequency band B2, but the distance between the feeding points 23a and 22a is sufficient and thus interference is hard to occur.

The resonance frequency concerning the first antenna 21 (peak position of C1) and the resonance frequency concerning the second antenna 22 (peak position of C2) are deviated from each other, whereby when diversity reception operation is performed, it is made possible to ensure a sufficient antenna gain over all band of the wide operation frequency band B1 as indicated by the characteristic curve CT.

The antennas 21, 22, and 23 and the input terminals 31a, 31b, and 32a can also be directly connected; generally, various circuit elements often are inserted as described later. In the case, about for each of the resonance frequencies, the characteristic needs to be determined as the whole characteristic containing not only the resonance frequency of each antenna, but also the characteristics of various inserted circuit elements. In the embodiment, not only the antenna element, but also components from the antenna element to the component before the input terminal of the wireless circuit containing various circuit elements provided therebetween are assumed to be an antenna.

In the example shown in FIG. 2, the frequency characteristic concerning the antenna gain is considered. However, the characteristic can also be determined considering the signal to noise ratio (S/N) in input of each of the wireless circuits 31 and 32 in place of the antenna gain.

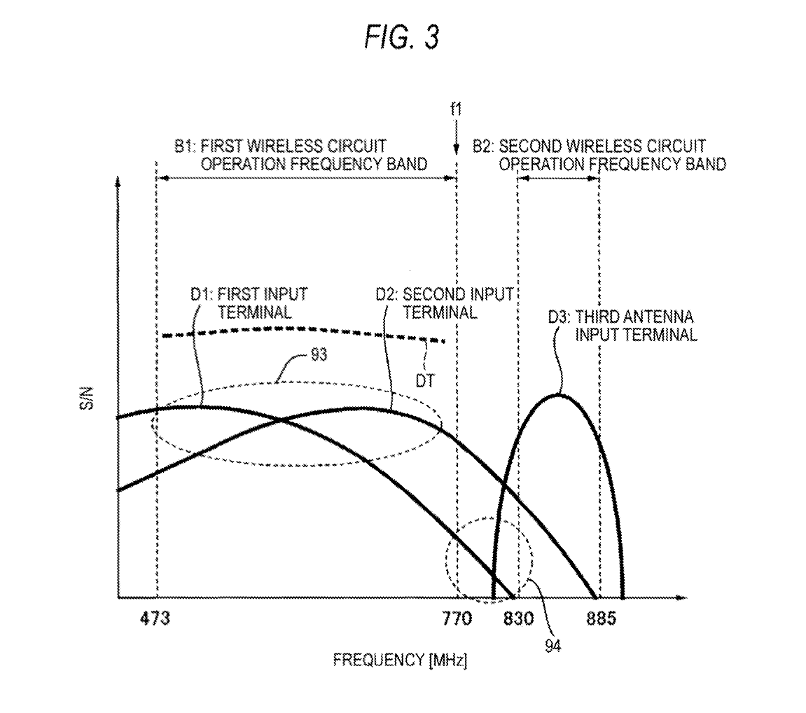

FIG. 3 is a characteristic drawing to represent a specific example of the frequency characteristic of the signal to noise ratio (S/N) in the input terminal of each connected wireless circuit as for each antenna installed in the mobile wireless terminal according to the first embodiment.

In the example shown in FIG. 3, a characteristic curve D1 represents the frequency characteristic of the signal to noise ratio (S/N) as for a signal input from the first antenna 21 to the first input terminal 31a of the first wireless circuit 31, a characteristic curve D2 represents the frequency characteristic of the signal to noise ratio as for a signal input from the second antenna 22 to the second input terminal 31b of the first wireless circuit 31, and a characteristic curve DT represents the frequency characteristic of the signal to noise ratio of a total input signal obtained as a result of the diversity reception operation of the first antenna 21 and the second antenna 22.

The resonance frequency concerning the first antenna 21 and the resonance frequency concerning the second antenna 22 are deviated from each other as with the example shown in FIG. 2 or the characteristic of each circuit element inserted between each antenna and the input terminals 31a and 31b is considered, whereby the frequency characteristic of the signal to noise ratio of the input signal to the first wireless circuit 31 in each input terminal can be determined like the frequency characteristic shown in FIG. 3.

In the example shown in FIG. 3, about the first input terminal 31a from the first antenna 21 near to the feeding point 23a of the third antenna 23, as shown in the characteristic curve D1, the signal to noise ratio (S/N) at least at the upper limit frequency f2 (770 MHz) is determined so as to become smaller than the signal to noise ratio of the characteristic curve D2 of the frequency characteristic of the second input terminal 31b from the second antenna 22. That is, the S/N in the first input terminal 31a is high in a low band of the operation frequency band B1 and the S/N in the second input terminal 31b is high in a high band of the operation frequency band B1. The diversity reception operation is performed using the first antenna 21 and the second antenna 22, whereby the characteristic of the portion surrounded by a dashed line 93 in the figure is combined and as a result, high S/N is obtained over all band of the operation frequency band B1 as indicated by the characteristic curve DT.

The frequency at which the level of a signal input from the first antenna 21 to the first input terminal 31a becomes a peak (peak position of D1) is at a large distance from the upper limit frequency f1 and the operation frequency band B2. The S/N of the first input terminal 31a from the first antenna 21 in the operation frequency band B2 becomes sufficient low like the portion surrounded by a dashed line 94 in the figure. Therefore, electromagnetic coupling of the third antenna 23 operating in the operation frequency band B2 with the first antenna 21 is hard to occur although the distance is near, and interference of the third antenna 23 and the first antenna 21 is suppressed.

In the second antenna 22, the frequency at which the level of a signal input to the second input terminal 31b becomes a peak (peak position of D2) is near to the upper limit frequency f1 and the operation frequency band B2, but the distance between the feeding points 23a and 22a is sufficient and thus interference is hard to occur.

The frequency at which the level of a signal input from the first antenna 21 to the first input terminal 31a becomes a peak (peak position of D1) and the frequency at which the level of a signal input from the second antenna 22 to the second input terminal 31b becomes a peak (peak position of D2) are deviated from each other, whereby when the diversity reception operation is performed, it is made possible to ensure a sufficient antenna gain over all band of the wide operation frequency band B1 as indicated by the characteristic curve DT.

Several specific configuration examples concerning a circuit from the first antenna 21 and the second antenna 22 to each input terminal of the first wireless circuit 31 (antenna circuit) are shown below:

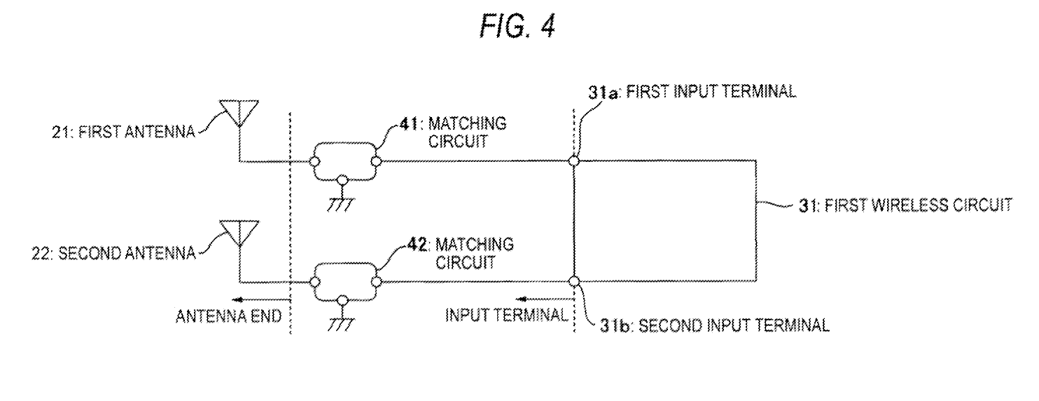

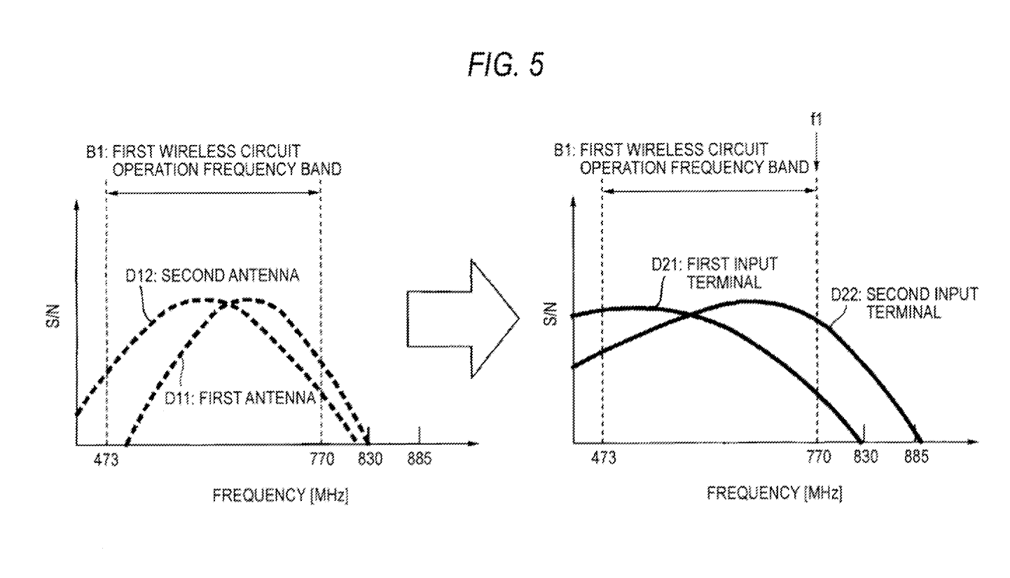

FIGS. 4 and 5 show a first configuration example concerning the antenna circuit of the mobile wireless terminal of the first embodiment. FIG. 4 is a configuration drawing of the first configuration example of the antenna circuit and FIG. 5 is a characteristic drawing to show the frequency characteristic of the first configuration example of the antenna circuit.

In the first example, to match impedance, a matching circuit 41 is provided between the first antenna 21 and the first input terminal 31a and a matching circuit 42 is provided between the second antenna 22 and the second input terminal 31b.

In FIG. 5, a characteristic curve D11 represents the frequency characteristic of the signal to noise ratio (S/N) of a signal at an output end of the first antenna 21, a characteristic curve D12 represents the frequency characteristic of the signal to noise ratio of a signal at an output end of the second antenna 22, a characteristic curve D21 represents the signal to noise ratio of a signal in a first input terminal 31a, and a characteristic curve D22 represents the signal to noise ratio of a signal in a second input terminal 31b.

That is, although the frequency characteristic of the element of the first antenna 21 is like the characteristic curve D11, as the whole first antenna 21, resonance frequency changes because of the effect of the matching circuit 41 and a signal of a frequency characteristic like the characteristic curve D21 is input to the first input terminal 31a. Although the frequency characteristic of the element of the second antenna 22 is like the characteristic curve D12, as the whole second antenna 22, resonance frequency changes because of the effect of the matching circuit 42 and a signal of a frequency characteristic like the characteristic curve D22 is input to the second input terminal 31b.

Also in the first configuration example, at the upper limit frequency f1, the signal to noise ratio of the characteristic curve D21 is smaller than the signal to noise ratio of the characteristic curve D22. Thus, even if the first antenna 21 and the third antenna 23 are near to each other, electromagnetic coupling of the third antenna 23 operating in the operation frequency band B2 with the first antenna 21 is hard to occur, and interference of the third antenna 23 and the first antenna 21 is suppressed.

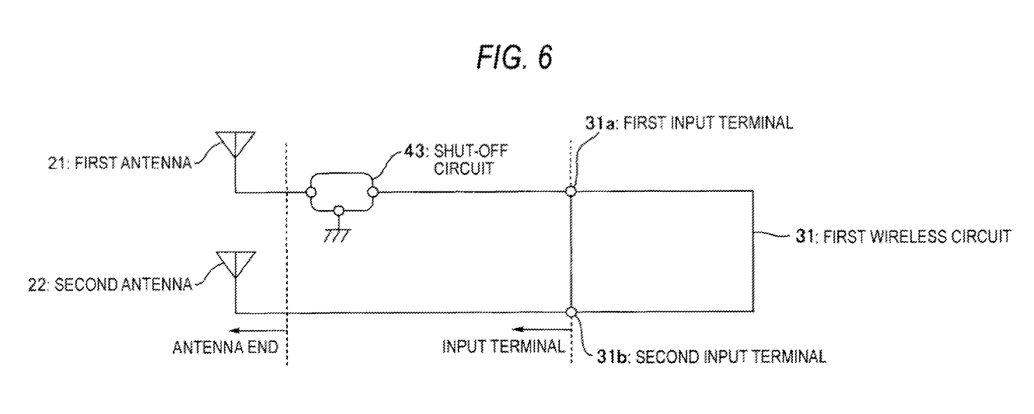

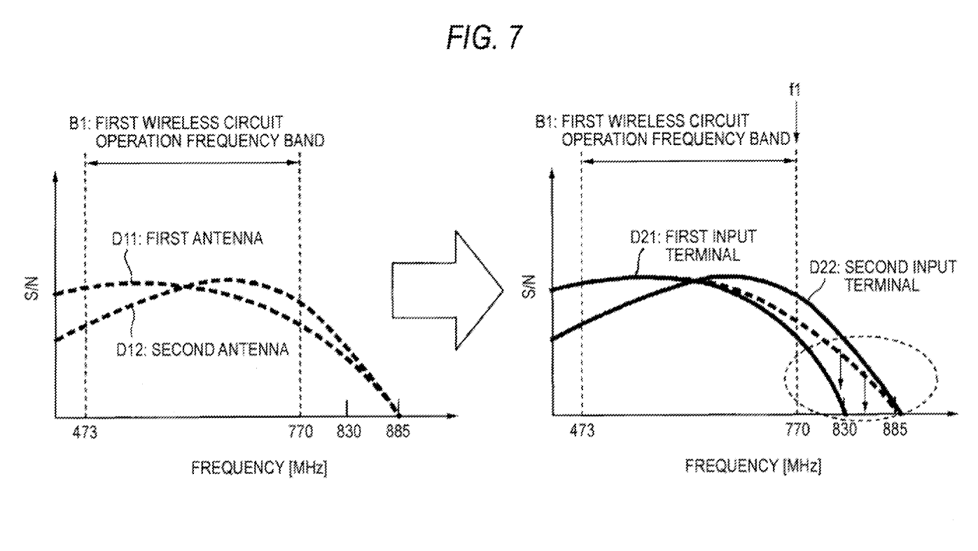

FIGS. 6 and 7 show a second configuration example concerning the antenna circuit of the mobile wireless terminal of the first embodiment. FIG. 6 is a configuration drawing of the second configuration example of the antenna circuit and FIG. 7 is a characteristic drawing to show the frequency characteristic of the second configuration example of the antenna circuit.

In the second configuration example, a shut-off circuit 43 is provided between the first antenna 21 and the first input terminal 31a, and the second antenna 22 and the second input terminal 31b are directly connected. The shut-off circuit 43 is a circuit element (filter) for adjusting the frequency characteristic. As the shut-off circuit 43, for example, a parallel resonance circuit (trap circuit) having a coil and a capacitor connected in parallel, a high band shut-off filter (low-pass filter) implemented as a serial resonance circuit having a coil and a capacitor connected in series, etc., can be used.

In FIG. 7, a characteristic curve D11 represents the frequency characteristic of the signal to noise ratio (S/N) of a signal at the output end of the first antenna 21, a characteristic curve D12 represents the frequency characteristic of the signal to noise ratio of a signal at an output end of the second antenna 22, a characteristic curve D21 represents the signal to noise ratio of a signal in the first input terminal 31a, and a characteristic curve D22 represents the signal to noise ratio of a signal in the second input terminal 31b.

That is, although the frequency characteristic of the element of the first antenna 21 is like the characteristic curve D11, as the whole first antenna 21, a high-band (band containing the operation frequency band B2) component of the characteristic curve D11 is decreased or is shut off because of the effect of the shut-off circuit 43, and a signal of a frequency characteristic like the characteristic curve D21 is input to the first input terminal 31a.

Also in the second configuration example, at the upper limit frequency f1, the signal to noise ratio of the characteristic curve D21 is sufficiently smaller than the signal to noise ratio of the characteristic curve D22. Thus, even if the first antenna 21 and the third antenna 23 are near to each other, electromagnetic coupling of the third antenna 23 operating in the operation frequency band B2 with the first antenna 21 is hard to occur, and interference of the third antenna 23 and the first antenna 21 is suppressed.

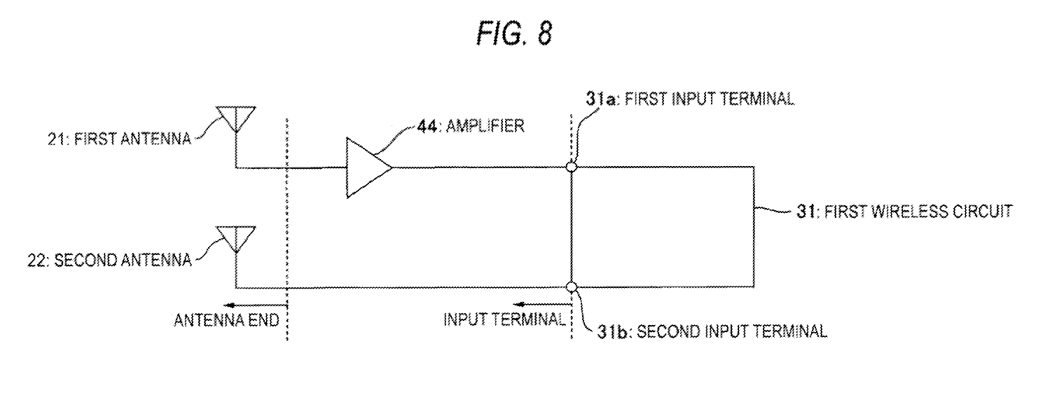

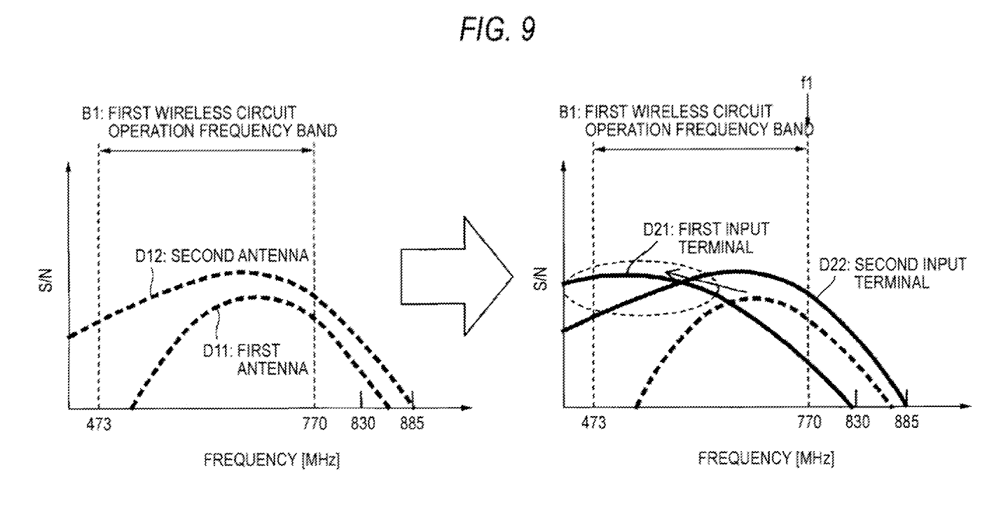

FIGS. 8 and 9 show a third configuration example concerning the antenna circuit of the mobile wireless terminal of the first embodiment. FIG. 8 is a configuration drawing of the third configuration example of the antenna circuit and FIG. 9 is a characteristic drawing to show the frequency characteristic of the third configuration example of the antenna circuit.

In the third configuration example, an amplifier 44 is provided between the first antenna 21 and the first input terminal 31a and the second antenna 22 and the second input terminal 31b are directly connected. The amplifier 44 is a circuit element for adjusting the gain and the frequency characteristic of the first antenna 21. For example, a low noise amplifier (LNA) is used as the amplifier 44. If the noise factor (NF) of the amplifier 44 is small as compared with the noise factor of the first wireless circuit 31, the noise factor of the whole circuit lowers and the improvement effect of the signal to noise ratio can be provided.

In FIG. 9, a characteristic curve D11 represents the frequency characteristic of the signal to noise ratio (S/N) of a signal at the output end of the first antenna 21, a characteristic curve D12 represents the frequency characteristic of the signal to noise ratio of a signal at an output end of the second antenna 22, a characteristic curve D21 represents the signal to noise ratio of a signal in the first input terminal 31a, and a characteristic curve D22 represents the signal to noise ratio of a signal in the second input terminal 31b.

That is, although the frequency characteristic of the element of the first antenna 21 is like the characteristic curve D11, as the whole first antenna 21, the frequency characteristic of the characteristic curve D11 is adjusted because of the effect of the amplifier 44, the S/N of a low band increases, and the S/N of a high band decreases, and a signal of a frequency characteristic like the characteristic curve D21 is input to the first input terminal 31a.

Actually, the amplifier is assumed to be a concentrated constant and thus impedance matching of the first antenna 21 is performed using the amplifier 44 and the frequency characteristic of the voltage standing wave ratio (VSWR) from the first antenna 21 to the first input terminal 31a is adjusted, whereby the frequency characteristic of the signal to noise ratio can be adjusted.

Realistically, the noise factor of the amplifier 44 changes according to input impedance and the input impedance varies for each frequency. Then, a characteristic (NF map) representing the relationship between the noise factor and the input impedance for each frequency is considered and the output impedance of the first antenna 21 is adjusted, whereby the frequency characteristic of the noise factor can be adjusted and the frequency characteristic of the signal to noise ratio can be adjusted.

Therefore, the amplifier 44 can provide the adjustment effect of the frequency characteristic of S/N and the improvement effect of S/N.

Also in the third configuration example, at the upper limit frequency f1, the signal to noise ratio of the characteristic curve D21 is sufficiently smaller than the signal to noise ratio of the characteristic curve D22. Thus, if the first antenna 21 and the third antenna 23 are near to each other, electromagnetic coupling of the third antenna 23 operating in the operation frequency band B2 with the first antenna 21 is hard to occur, and interference of the third antenna 23 and the first antenna 21 is suppressed.

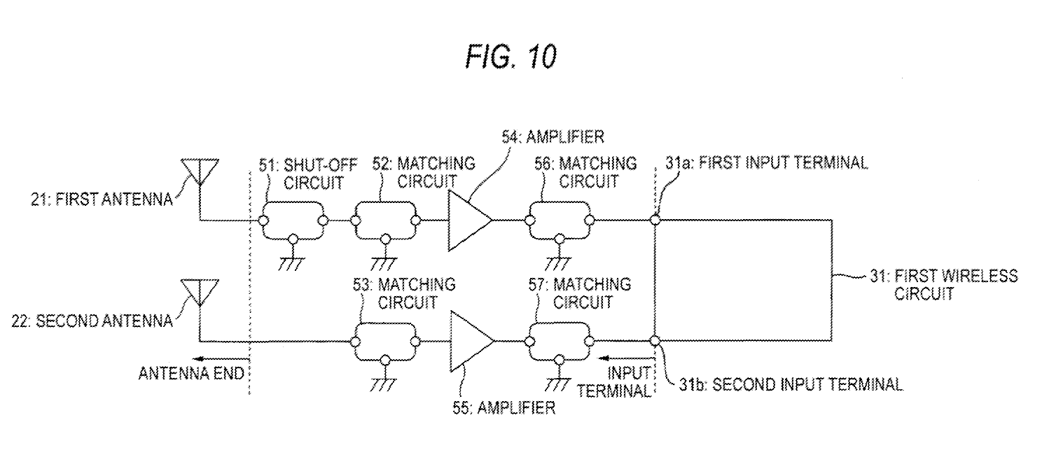

FIG. 10 is a configuration drawing of the fourth configuration example concerning the antenna circuit of the mobile wireless terminal of the first embodiment.

Combination circuits of various circuit elements as in the first to third configuration examples are provided between the first antenna 21 and the first input terminal 31a and between the second antenna 22 and the second input terminal 31b.

That is, a shut-off circuit 51 is connected to the output end of the first antenna 21, a matching circuit 52 is connected to output of the shut-off circuit 51, an amplifier 54 is connected to output of the matching circuit 52, a matching circuit 56 is connected to output of the amplifier 54, and output of the matching circuit 56 is connected to the first input terminal 31a. A matching circuit 53 is connected to the output end of the second antenna 22, an amplifier 55 is connected to output of the matching circuit 53, a matching circuit 57 is connected to output of the amplifier 55, and output of the matching circuit 57 is connected to the second input terminal 31b.

Also in the fourth embodiment, like the first to third embodiments, the frequency characteristic of the signal to noise ratio in the first input terminal 31a and the frequency characteristic of the signal to noise ratio in the second input terminal 31b can be adjusted. Therefore, if the first antenna 21 and the third antenna 23 are near to each other, electromagnetic coupling of the third antenna 23 operating in the operation frequency band B2 with the first antenna 21 is adjusted so as to be hard to occur, and interference of the third antenna 23 and the first antenna 21 can be suppressed.

As described above, in the first embodiment, when the first antenna 21 and the second antenna 22 are connected to the first wireless circuit 31, the third antenna 23 is connected to the second wireless circuit 32, and the operation frequency band B2 of the second wireless circuit 32 is near in a higher band than the operation frequency band B1 of the first wireless circuit 31, the feeding point 23a of the third antenna is placed at a position nearer to the feeding point 21a of the first antenna than the feeding point 22a of the second antenna. The resonance frequency of the first antenna 21 is set in a low frequency band in the operation frequency band B1 of the first wireless circuit 31 and the resonance frequency of the second antenna 22 is set in a high frequency band (frequency band higher than the resonance frequency of the first antenna 21) in the operation frequency band B1 of the first wireless circuit 31.

As the frequency characteristics of the first antenna 21 and the second antenna 22, as for the antenna gain, in the operation frequency band B1 of the first wireless circuit 31, the gain of the first antenna 21 is set higher than the gain of the second antenna 22 in a low frequency band and the gain of the first antenna 21 is set higher than the gain of the second antenna 22 in a high frequency band. As the frequency characteristics of the first antenna 21 and the second antenna 22, as for the signal to noise ratio in the input terminal of the first wireless circuit 31 to which each antenna is connected, in the operation frequency band B1 of the first wireless circuit 31, the signal to noise ratio in the first input terminal 31a from the first antenna 21 to the first input terminal 31a is set higher than the signal to noise ratio in the second input terminal 31b from the second antenna 22 to the second input terminal 31b in a low frequency band and the signal to noise ratio in the first input terminal 31a is set higher than the signal to noise ratio in the second input terminal 31b in a high frequency band.

About the characteristic of the resonance frequencies of the first antenna 21 and the second antenna 22, the antenna gain, the signal to noise ratio, etc., the frequency characteristic of each antenna element may be set as the frequency characteristic of the antenna element or the frequency characteristic of the antenna element containing the circuit elements of the matching circuits, the amplifier, etc., connected to the antenna element or the frequency characteristic of the whole antenna containing the characteristic of the circuit elements from each antenna to the input terminal of the wireless circuit may be set.

According to the configuration as described above, if the distance between the first antenna 21 and the third antenna 23 is near, the antenna gain and the signal to noise ratio of the first antenna 21 become sufficiently small in the operation frequency band B2 in which the third antenna 23 and the second wireless circuit 32 operate, the mutual effect of the first antenna 21 and the third antenna 23 can be decreased, and electromagnetic coupling can be prevented from occurring. Since the second antenna 22 and the third antenna 23 can be installed at a distance from each other, interference of the second antenna 22 and the third antenna 23 can be suppressed. Therefore, interference between the first antenna 21 and the third antenna 23 and interference between the second antenna 22 and the third antenna 23 can be suppressed and degradation of the characteristic can be prevented. The first wireless circuit 31 can perform the diversity reception operation using the first antenna 21 and the second antenna 22 different in resonance frequency. Thus, if the operation frequency band B1 of the first wireless circuit 31 is very wide as in reception of a digital broadcast, it is made possible to ensure a sufficient antenna gain over all band of the operation frequency band B1.

### Second Embodiment

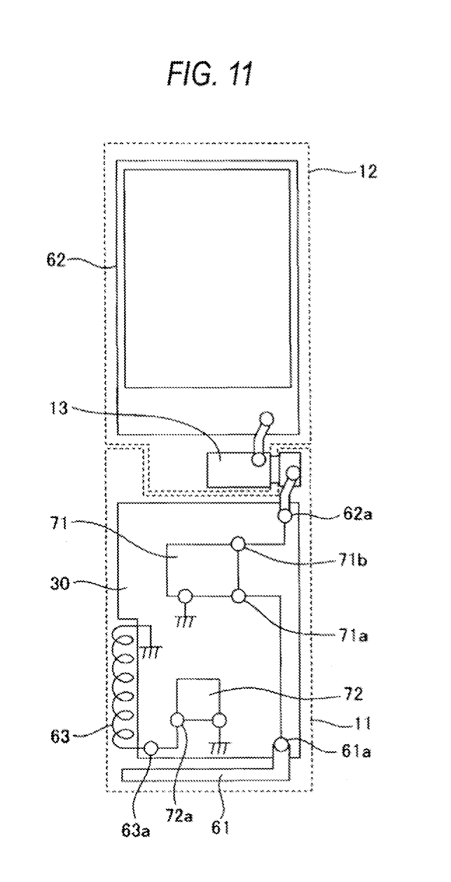

FIG. 11 is a front view to represent the configuration of a main part of a mobile wireless terminal according to a second embodiment of the invention. The second embodiment is a modified example provided by changing a part of the configuration of the first embodiment. A configuration and operation similar to those of the first embodiment will not be discussed again and the description centers on differences.

A cabinet of the mobile wireless terminal of the second embodiment can be folded like that of the first embodiment and includes a lower cabinet 11, an upper cabinet 12, and a hinge 13 for joining them. In the mobile wireless terminal, a board 30 in which various electronic circuits are built is placed on the lower cabinet 11 side. A first wireless circuit 71 and a second wireless circuit 72 are installed on the board 30.

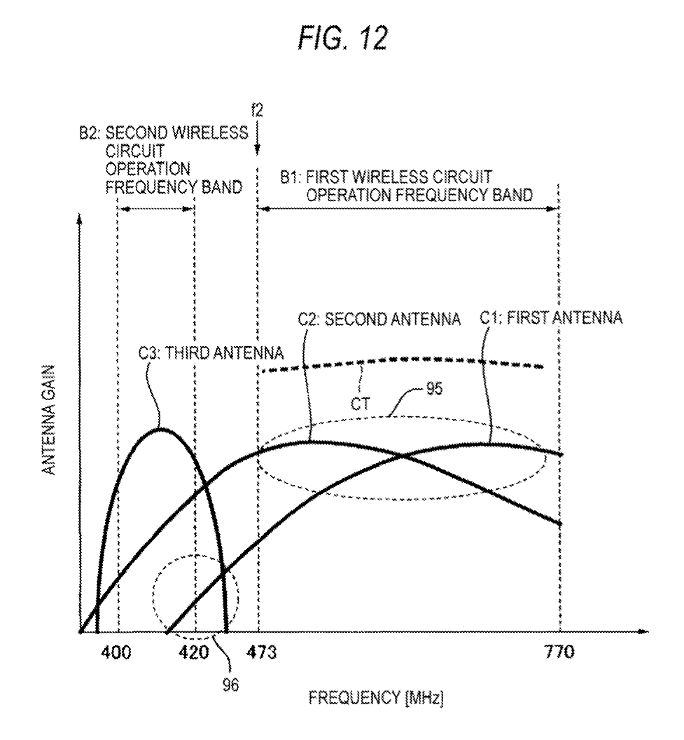

FIG. 12 is a characteristic drawing to represent specific examples of the frequency characteristic concerning the gain of each antenna and the operation frequency band of each wireless circuit installed in the mobile wireless terminal according to the second embodiment.

The second embodiment differs from the first embodiment largely in frequency bands in which the first wireless circuit 71 and the second wireless circuit 72 operate. That is, as shown in FIG. 12, the first wireless circuit 71 receives a wireless signal within the range of an operation frequency band B1 (473 MHz to 770 MHz) and the second wireless circuit 72 has a function of conducting wireless communications using a signal within the range of an operation frequency band B2 (440 MHz to 420 MHz) lower than the operation frequency band B1. This means that the higher and lower relationship between the operation frequency band B1 and the operation frequency band B2 is opposite to that in the first embodiment.

The cabinet of the mobile wireless terminal of the embodiment includes three independent antennas. That is, a second antenna 62 is placed on the upper cabinet 12 side and a first antenna 61 and a third antenna 63 are placed on the lower cabinet 11 side.

The first antenna 61 and the second antenna 62 are electrically connected to input terminals 71a and 71b of the first wireless circuit 71 respectively. The first wireless circuit 71 performs diversity reception operation using the first antenna 61 and the second antenna 62. That is, the reception signals of the antennas 61 and 62 different in frequency characteristic are combined, whereby it is made possible to obtain a high antenna gain over a very wide frequency band.

The second antenna 62 functions as a dipole antenna using the cabinet. That is, a conductive metal frame formed so as to cover a wide range of the upper cabinet 12 is the main body of the second antenna 62 and is connected to the first input terminal 71a of the first wireless circuit 71 on the board 30 via the metal hinge 13 and a feeding point 62a. A ground pattern formed of metal foil exists on the board 30 and the metal frame of the second antenna 62, the hinge 13, and the ground pattern form the dipole antenna. On the other hand, the first antenna 61 is formed of an elongated metal member, etc., and functions as a monopole antenna.

In the example shown in FIG. 12, a characteristic curve C1 represents the frequency characteristic of the antenna gain concerning the first antenna 61, a characteristic curve C2 represents the frequency characteristic of the antenna gain concerning the second antenna 62, and a characteristic curve CT represents the frequency characteristic of the total antenna gain obtained as a result of the diversity reception operation of the first antenna 61 and the second antenna 62.

That is, in the example shown in FIG. 12, a gain peak (corresponding to resonance frequency) exists on the high band side of the operation frequency band B1 about the characteristic of the first antenna 61 (C1), and a gain peak exists on the low band side of the operation frequency band B1 about the characteristic of the second antenna 62 (C2). That is, the first antenna 61 covers the high band of the operation frequency band B1 and the second antenna 62 covers the low band of the operation frequency band B1. The diversity reception operation is performed using the first antenna 61 and the second antenna 62, whereby the characteristic of the portion surrounded by a dashed line 95 in the figure is combined and as a result, a high antenna gain is obtained over all band of the operation frequency band B1 as indicated by the characteristic curve CT.

The third antenna 63 is electrically connected to an input terminal 72a of the second wireless circuit 72. The third antenna 63 is formed of a coil-like metal member, etc., and functions as a helical antenna. In the example shown in FIG. 12, a characteristic curve C3 represents the frequency characteristic concerning the antenna gain of the third antenna 63. That is, a radio wave within the range of the operation frequency band B2 of the second wireless circuit 72 can be transmitted and received by using the third antenna 63.

The placement configuration and the frequency characteristics of the first antenna 61, the second antenna 62, and the third antenna 63 will be discussed in detail.

As shown in FIG. 11, a feeding point 61a of the first antenna 61 and a feeding point 63a of the third antenna 63 exist on the lower end side of the lower cabinet 11 in the figure and a feeding point 62a of the second antenna 62 exist on the upper end side of the lower cabinet 11 in the figure. Therefore, the distance between the first antenna 61 and the third antenna 63 and the second antenna 62 is comparatively large (for example, about 90 mm); whereas, the feeding point 61a of the first antenna 61 and the feeding point 63a of the third antenna 63 are near to each other.

Thus, interference is hard to occur between the first antenna 61 and the second antenna 62 and between the third antenna 63 and the second antenna 62; whereas, interference is easy to occur because of electromagnetic coupling between the first antenna 61 and the third antenna 63 near to each other.

In the embodiment, to suppress interference between the antenna because of electromagnetic coupling, the relative position relationship among the first antenna 61, the second antenna 62, and the third antenna 63 and the frequency characteristics of the first antenna 61 and the second antenna 62 are specially devised.

For example, the resonance frequency concerning the first antenna 61 (peak position of C1) and the resonance frequency concerning the second antenna 62 (peak position of C2) are deviated from each other like the frequency characteristic of antenna gain shown in FIG. 12 and about the first antenna 61 near to the feeding point 63a of the third antenna 63, the antenna gain at least at lower limit frequency f2 (473 MHz) as shown in characteristic curve C1 is smaller than characteristic curve C2 of antenna gain characteristic of the second antenna 62.

Accordingly, the resonance frequency concerning the first antenna 61 (peak position of C1) is at a large distance from the lower limit frequency f2 and the operation frequency band B2 and the antenna gain of the first antenna 61 becomes sufficiently low in the operation frequency band B2 like the portion surround by a dashed line 96 in the figure. Therefore, electromagnetic coupling of the third antenna 63 operating in the operation frequency band B2 with the first antenna 61 is hard to occur although the distance is near, and interference of the third antenna 63 and the first antenna 61 is suppressed.

About the second antenna 62, the resonance frequency (peak position of C2) is near to the upper limit frequency f2 and the operation frequency band B2, but the distance between the feeding points 63a and 62a is sufficient and thus interference is hard to occur.

The resonance frequency concerning the first antenna 61 (peak position of C1) and the resonance frequency concerning the second antenna 62 (peak position of C2) are deviated from each other, whereby when diversity reception operation is performed, it is made possible to ensure a sufficient antenna gain over all band of the wide operation frequency band B1 as indicated by the characteristic curve CT.

The antennas 61, 62, and 63 and the input terminals 71a, 71b, and 72a can also be directly connected; generally, various circuit elements often are inserted as described above. In the case, about for each of the resonance frequencies, the characteristic needs to be determined as the whole characteristic containing not only the resonance frequency of each antenna, but also the characteristics of various inserted circuit elements.

In the example shown in FIG. 12, the frequency characteristic concerning the antenna gain is considered. However, the characteristic can also be determined considering the signal to noise ratio (S/N) in input of each of the wireless circuits 71 and 72 in place of the antenna gain.

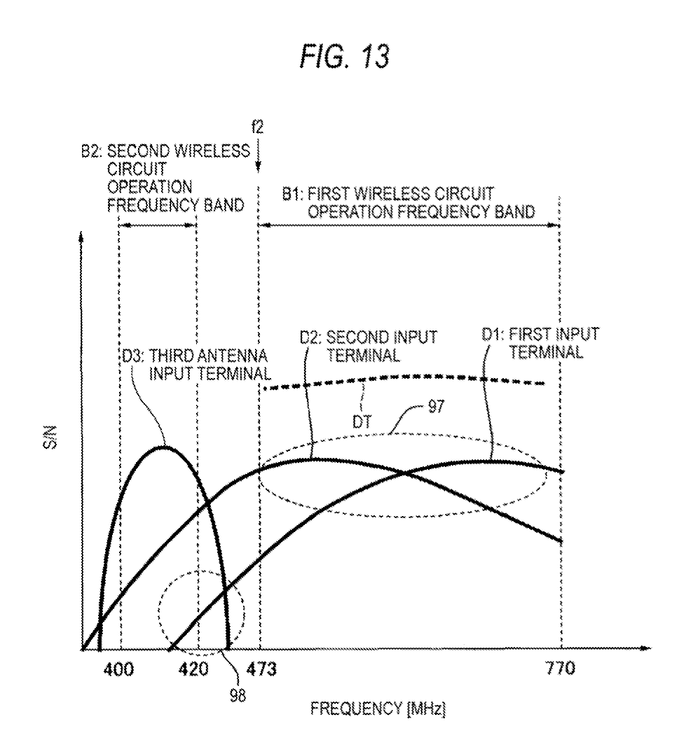

FIG. 13 is a characteristic drawing to represent a specific example of the frequency characteristic of the signal to noise ratio (S/N) in the input terminal of each connected wireless circuit as for each antenna installed in the mobile wireless terminal according to the second embodiment.

In the example shown in FIG. 13, a characteristic curve D1 represents the frequency characteristic of the signal to noise ratio (S/N) as for a signal input from the first antenna 61 to the first input terminal 71a of the first wireless circuit 71, a characteristic curve D2 represents the frequency characteristic of the signal to noise ratio as for a signal input from the second antenna 62 to the second input terminal 71b of the first wireless circuit 71, and a characteristic curve DT represents the frequency characteristic of the signal to noise ratio of a total input signal obtained as a result of the diversity reception operation of the first antenna 61 and the second antenna 62.

The resonance frequency concerning the first antenna 61 and the resonance frequency concerning the second antenna 62 are deviated from each other as with the example shown in FIG. 12 or the characteristic of each circuit element inserted between each antenna and the input terminals 71a and 71b is considered, whereby the frequency characteristic of the signal to noise ratio of the input signal to the first wireless circuit 71 in each input terminal can be determined like the frequency characteristic shown in FIG. 13.

In the example shown in FIG. 13, about the first input terminal 71a from the first antenna 61 near to the feeding point 63a of the third antenna 63, as shown in the characteristic curve D1, the signal to noise ratio (S/N) at least at the lower limit frequency f2 (473 MHz) is determined so as to become smaller than the signal to noise ratio of the characteristic curve D2 of the frequency characteristic of the second input terminal 71b from the second antenna 62. That is, the S/N in the first input terminal 71a is high in a high band of the operation frequency band B1 and the S/N in the second input terminal 71b is high in a low band of the operation frequency band B1. The diversity reception operation is performed using the first antenna 61 and the second antenna 62, whereby the characteristic of the portion surrounded by a dashed line 97 in the figure is combined and as a result, high S/N is obtained over all band of the operation frequency band B1 as indicated by the characteristic curve DT.

The frequency at which the level of a signal input from the first antenna 61 to the first input terminal 71a becomes a peak (peak position of D1) is at a large distance from the lower limit frequency f2 and the operation frequency band B2. The S/N of the first input terminal 71a from the first antenna 61 in the operation frequency band B2 becomes sufficient low like the portion surrounded by a dashed line 98 in the figure. Therefore, electromagnetic coupling of the third antenna 63 operating in the operation frequency band B2 with the first antenna 61 is hard to occur although the distance is near, and interference of the third antenna 63 and the first antenna 61 is suppressed.

About the second antenna 62, the frequency at which the level of a signal input to the second input terminal 71b becomes a peak (peak position of D2) is near to the lower limit frequency f2 and the operation frequency band B2, but the distance between the feeding points 63a and 62a is sufficient and thus interference is hard to occur.

The frequency at which the level of a signal input from the first antenna 61 to the first input terminal 71a becomes a peak (peak position of D1) and the frequency at which the level of a signal input from the second antenna 62 to the second input terminal 71b becomes a peak (peak position of D2) are deviated from each other, whereby when the diversity reception operation is performed, it is made possible to ensure a sufficient antenna gain over all band of the wide operation frequency band B1 as indicated by the characteristic curve DT.

As for the circuit from the first antenna 61 and the second antenna 62 to each input terminal of the first wireless circuit (antenna circuit), a similar configuration to that of the first embodiment shown in FIGS. 4 to 10 is considers about circuit elements inserted between the first antenna 61 and the first input terminal 71a and between the second antenna 62 and the second input terminal 71b.

As described above, in the second embodiment, when the first antenna 61 and the second antenna 62 are connected to the first wireless circuit 71, the third antenna 63 is connected to the second wireless circuit 72, and the operation frequency band B2 of the second wireless circuit 72 is near in a lower band than the operation frequency band B1 of the first wireless circuit 71, the feeding point 63a of the third antenna is placed at a position nearer to the feeding point 61a of the first antenna than the feeding point 62a of the second antenna. The resonance frequency of the first antenna 61 is set in a high frequency band in the operation frequency band B1 of the first wireless circuit 71. The resonance frequency of the second antenna 62 is set in a low frequency band in the operation frequency band B1 of the first wireless circuit 71 (frequency band lower than the resonance frequency of the first antenna 61).

As the frequency characteristics of the first antenna 61 and the second antenna 62, as for the antenna gain, in the operation frequency band B1 of the first wireless circuit 71, the gain of the first antenna 61 is set higher than the gain of the second antenna 62 in a high frequency band and the gain of the first antenna 61 is set higher than the gain of the second antenna 62 in a low frequency band. As the frequency characteristics of the first antenna 61 and the second antenna 62, as for as for the signal to noise ratio in the input terminal of the first wireless circuit 71 to which each antenna is connected, in the operation frequency band B1 of the first wireless circuit 71, the signal to noise ratio in the first input terminal 71a from the first antenna 61 to the first input terminal 71a is set higher than the signal to noise ratio in the second input terminal 71b from the second antenna 62 to the second input terminal 71b in a high frequency band and the signal to noise ratio in the first input terminal 71a is set higher than the signal to noise ratio in the second input terminal 71b in a low frequency band.

About the characteristic of the resonance frequencies of the first antenna 61 and the second antenna 62, the antenna gain, the signal to noise ratio, etc., the frequency characteristic of each antenna element may be set as the frequency characteristic of the antenna element or the frequency characteristic of the antenna element containing the circuit elements of the matching circuits, the amplifier, etc., connected to the antenna element or the frequency characteristic of the whole antenna containing the characteristic of the circuit elements from each antenna to the input terminal of the wireless circuit may be set.

According to the configuration as described above, if the distance between the first antenna 61 and the third antenna 63 is near, the antenna gain and the signal to noise ratio of the first antenna 61 become sufficiently small in the operation frequency band B2 in which the third antenna 63 and the second wireless circuit 72 operate, the mutual effect of the first antenna 61 and the third antenna 63 can be decreased, and electromagnetic coupling can be prevented from occurring. Since the second antenna 62 and the third antenna 63 can be installed at a distance from each other, interference of the second antenna 62 and the third antenna 63 can be suppressed. Therefore, interference between the first antenna 61 and the third antenna 63 and interference between the second antenna 62 and the third antenna 63 can be suppressed and degradation of the characteristic can be prevented. The first wireless circuit 71 can perform the diversity reception operation using the first antenna 61 and the second antenna 62 different in resonance frequency. Thus, if the operation frequency band B1 of the first wireless circuit 71 is very wide as in reception of a digital broadcast, it is made possible to ensure a sufficient antenna gain over all band of the operation frequency band B1.

Therefore, according to the embodiments described above, when two or more wireless circuits operating in two frequency bands near to each other are installed and three or more antennas are installed in a small cabinet, for example, like a mobile telephone terminal, interference between the antennas can be suppressed and degradation of the characteristic can be prevented.

It is to be understood that the invention is not limited to the items shown in the embodiments described above and the invention is also intended for those skilled in the art to make modifications and application based on the Description of the invention and well-known arts and the modifications and the application are contained in the scope to seek protection.

This application is based on Japanese Patent Application (No. 2008-113786) filed on Apr. 24, 2008, which is incorporated herein by reference.

### INDUSTRIAL APPLICABILITY

The invention has the advantage that when three or more antennas and a plurality of wireless circuits using wireless frequency bands near to each other are installed on a cabinet whose size is limited, it is made possible to suppress degradation of characteristic caused by electromagnetic coupling between the antennas; it is useful as a mobile wireless terminal, etc., installing a plurality of antennas and a plurality of wireless circuits that can be applied to a mobile telephone terminal, etc., for example.

1. A mobile wireless terminal comprising,
a board;
a first wireless circuit which is mounted on the board and is adapted to perform diversity reception operation;
a second wireless circuit mounted on the board;
a first antenna connected to the first wireless circuit;
a second antenna connected to the first wireless circuit; and
a third antenna connected to the second wireless circuit,
wherein a feeding point of the third antenna is placed at a position nearer to a feeding point of the first antenna than a feeding point of the second antenna;
wherein the second wireless circuit operates in a second operation frequency band higher than a first operation frequency band in which the first wireless circuit operates, the second operation frequency band being near to the first operation frequency band; and
wherein a resonance frequency of the second antenna is set in a frequency band higher than a resonance frequency of the first antenna in the first operation frequency band.

2. The mobile wireless terminal according to claim 1, wherein an antenna gain of the first antenna is higher than an antenna gain of the second antenna at least in a low frequency band in the proximity of a lower limit frequency in the first operation frequency band; and
wherein the antenna gain of the second antenna is higher than the antenna gain of the first antenna at least in a high frequency band in the proximity of an upper limit frequency in the first operation frequency band.

3. The mobile wireless terminal according to claim 1 wherein, the first antenna is connected to the first wireless circuit through a first input terminal;
wherein the second antenna is connected to the first wireless circuit through a second input terminal;
wherein an input signal to noise ratio in the first input terminal is higher than an input signal to noise ratio in the second input terminal at least in a low frequency band in the proximity of a lower limit frequency in the first operation frequency band; and
wherein the input signal to noise ratio in the second input terminal is higher than the input signal to noise ratio in the first input terminal at least in a high frequency band in the proximity of an upper limit frequency in the first operation frequency band.

4. A mobile wireless terminal comprising:
a board;
a first wireless circuit which is mounted on the board and is adapted to perform diversity reception operation;
a second wireless circuit mounted on the board;
a first antenna connected to the first wireless circuit;
a second antenna connected to the first wireless circuit; and
a third antenna connected to the second wireless circuit,
wherein a feeding point of the third antenna is placed at a position nearer to a feeding point of the first antenna than a feeding point of the second antenna;
wherein the second wireless circuit operates in a second operation frequency band lower than a first operation frequency band in which the first wireless circuit operates, and the second operation frequency band being near to the first operation frequency band; and
wherein a resonance frequency of the second antenna is set in a frequency band lower than a resonance frequency of the first antenna in the first operation frequency band.

5. The mobile wireless terminal according to claim 4, wherein an antenna gain of the first antenna is higher than an antenna gain of the second antenna at least in a high frequency band in the proximity of an upper limit frequency in the first operation frequency band; and
wherein the antenna gain of the second antenna is higher than the antenna gain of the first antenna at least in a low frequency band in the proximity of a lower limit frequency in the first operation frequency band.

6. The mobile wireless terminal according to claim 4, wherein the first antenna is connected to the first wireless circuit through a first input terminal;
wherein the second antenna is connected to the first wireless circuit through a second input terminal;
wherein an input signal to noise ratio in the first input terminal is higher than the input signal to noise ratio in the second input terminal at least in a high frequency band in the proximity of an upper limit frequency in the first operation frequency band; and
wherein the input signal to noise ratio in the second input terminal is higher than the input signal to noise ratio in the first input terminal at least in a low frequency band in the proximity of a lower limit frequency in the first operation frequency band.
